(19) United States
(12) Patent Application Publication
(10) Pub. No.: US 2024/0209209 A1
(43) Pub. Date: Jun. 27, 2024

(54) AGE RATE RETARDING ADDITIVES FOR ASPHALT BINDERS

(71) Applicants: A.L.M. Holding Company, Onalaska, WI (US); Ergon Asphalt & Emulsions, Inc., Jackson, MS (US)

(72) Inventors: Gerald H. Reinke, La Crosse, WI (US); Gaylon l. Baumggardner, Arkadelphia, AR (US); Andrew Hanz, LaCrosse, WI (US)

(21) Appl. No.: 18/288,162

(22) PCT Filed: Apr. 26, 2022
(86) PCT No.: PCT/US2022/026310

§ 371 Date: Oct. 24, 2023

Related U.S. Application Data
(60) Provisional application No. 63/179,991, filed on Apr. 26, 2021.

(51) Int. Cl. C08L 95/00; C08K 5/01

(52) U.S. Cl. CPC C08L 95/00; C08K 5/01; C08L 2555/60

(57) ABSTRACT

This disclosure describes further age retarding additives for asphalt binders. These additives comprise three structural elements i) a fused hydrocarbon ring structure, ii) a polar element attached to the ring structure, and iii) an aliphatic element attached to the ring structure opposite the polar element.

Additives, processes, and procedures to retard the detrimental aging effects of asphalt binders have been reported. For example, the following published U.S. patent applications, published patent applications, and U.S. patent report that plant sterol additives when combined with asphalt binders, provide an improved asphalt binder having beneficial age retarding and aging rate properties compared to asphalt binders that do not include the reported additives. These documents include, but are not limited to, U.S. patent application Ser. No. 16/930,186; U.S. Pub. Nos 2016/032338 A1, 2018/0215919 A1, 2019/0265221 A1, 2019/0153229 A1, 2020/0354274A1, 2020/0207944 A1, 2020/0277497 A1, as well as U.S. Pat. No. 10,669,202. Each of these documents is incorporated by reference herein for the purpose of describing testing processes and analysis procedures that support the retardation or reduced aging rate of asphalt binders containing plant sterol additives (referred to as “sterol” or “sterols” in this disclosure).

### SUMMARY

This disclosure describes further age retarding additives for asphalt binders. These additives comprise three structural elements i) a fused hydrocarbon ring structure, ii) a polar element attached to the ring structure, and iii) an aliphatic element attached to the ring structure opposite the polar element.

These features may be schematically represented as the following illustrative phrase:

Polar Element A-Fused Ring Structure-Aliphatic Element R1

wherein the Polar Element A comprises, for example, halogen moieties, sulfur-based moieties, or nitrogen based moieties, wherein the Fused Ring Structure comprises, for example, multiple fused aliphatic rings of about 12 to about 24 carbon atoms, optionally including one or more attached methyl moieties, or one or more double bonds in one or more of the fused rings, and wherein the Aliphatic Element R1 comprises substituted or unsubstituted, linear or branched alkyl, or alkenyl moieties having about 2 to about 16 carbon atoms. In other embodiments, the Polar Element A may comprise a hydroxyl moiety when the fused ring structure is comprised of fused rings less than or greater than the fused 4 ring structures illustrated in Formulas 1 and 2 below.

Representative age rate retarding additives include, but are not limited to, additives having a fused 4 ring structure containing 2 methyl moieties according to Formula 1 or Formula 2.

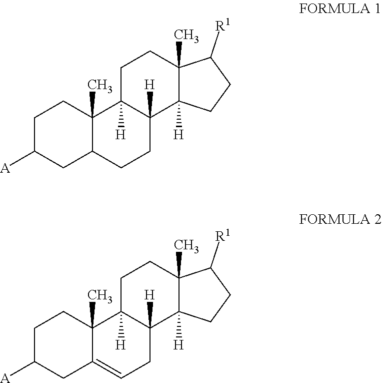

Other fused ring structures include embodiments that are, for example, 3 ring structures, 4 ring structures, 5 ring structures, or 6 ring structures. These embodiments include both saturated rings or unsaturated rings having one ore more double bonds in any of fused rings. The hydrocarbon fused ring structures are readily distinguished from fused ring structures that include aromatic rings, such as polycyclic aromatic compounds can be carcinogenic, toxic, or hazardous and are environmentally unsuitable. In contrast, the disclosed fused rings structures do not present an environmental risk and are well suited to be used as additives with low or no risk to the environment.

There are a many of sterol and stanol molecules having fused ring structures that are similar to the fused ring structures of Formula 1 and Formula 2. Representative examples of embodiments with similar fused ring structures include, but are not limited to, Δ5-avenosterol, Δ7-avenosterol, 5.alpha.-stigmast-8(14)-en-3-one, 5-ergosten-3-one, 22-methylcholesterol, brassicasterol, campesterol, campestanol, cholestan-4-ol, coprosterol, ergost-22-ene-1,3-diol, stigasterol, A7-stigasterol, stigmasterol, sitostanol, and β-sitosterol.

In other embodiments, any of the fused rings may include one or more alkyl moieties, such as methyl moieties, attached to the ring structure. The inclusion of methyl moieties is illustrated, for example, in Formulas 1 and 2 which include two methyl moieties attached to different rings.

Some embodiments of the fused ring structures in Formulas 1 and 2 also include suitable sites for the attachment of the polar element at, for example, the attachment site for A and the aliphatic element at, for example, attachment site for R¹.

In some embodiments, a suitable Polar Element A includes, for example, —OH, —ORₐ, —OCO—Rₐ, Rₐ—CO₂H, —F, —Cl, —Br, —SH, —SO—, —SO₂, —NH₂, —NHRₐ, or —N(RₐR_{b}), wherein Rₐ and R_{b} are C₁-C₁₀ linear or branched alkyl or alkenyl groups, optionally substituted with one or more hydroxyl moieties.

In some embodiments of this disclosure, the fused ring structure is substantially rigid, saturated or unsaturated, and essentially non-reactive. See, for example, FIGS. 1, 2, and 3. This three-dimensional topography is also illustrated by the space filling model provided together with additional physical properties in the internet-available document; Faller, Roland, UCD Biophysics 241: Membrane Biology, “1.6: Sterols and Sterol Induced Phases”, (Mar. 28, 2021); incorporated by reference in this disclosure. The three-dimensional topography is a fused ring structure that is rigid, saturated or unsaturated, and essentially non-reactive. When used as an asphalt binder additive, the saturated or unsaturated, hydrocarbon fused ring structure and the attached polar moiety and the attached aliphatic element are not changed as a result of the aging process associated with use of the asphalt binder combined with such additives in, for example, paving and roofing applications.

In some embodiments of this disclosure, the age rate retarding additives will have a calculated molecular weight in ranges of at least about 250 g/mol, about 250-650 g/mol, about 300-550 g/mol or about 325-425 g/mol as well as a melting point of at least 150° F. or higher or, in some embodiments, a melting point of about 250° F.-500° F.

In some embodiments of this disclosure, the function of the polar element may be shown by comparing a completely saturated compound that is nonpolar, cholestane, with the related polar compound, cholestanol, having a polar hydroxyl group attached to one end of a fused 4 ring structure opposite the aliphatic element R1. This comparison, as disclosed in detail below, indicates there is no age retarding benefit provided when cholestane is the additive, while cholestanol does retard the aging properties of an asphalt binder when it is used as an additive.

The details and data are further described in Comparative Example 1.

### DESCRIPTION OF THE DRAWINGS

FIGS. 1, 2, and 3 illustrate the three-dimensional topography of cholestane, cholestanol, and beta sitosterol.

FIGS. 4 and 5 graphically represent high temperature PG grade data for control and age retarding additive samples.

FIGS. 6 and 7 graphically represent low temperature m-critical grade data for control and age retarding additive samples.

FIGS. 8, 9, and 10 are Iatroscan plot comparisons of selective Pressure Vessel Aged (PAV) samples.

### DETAILED DESCRIPTION

In some embodiments of this disclosure, the asphalt binder may be virgin asphalt (typically asphalt binder that has not been aged or used in previous applications) or the asphalt binder may include a blend of virgin and aged or previously used asphalt binders (generally referred to as Reclaimed or Recycled Asphalt Binders). In some embodiments, the binder blend includes virgin binder and binder extracted from RAP (reclaimed asphalt pavement) or RAS (reclaimed asphalt shingles) or both RAP and RAS. In certain embodiments, the RAS is extracted from manufacturer asphalt shingle waste, or from consumer asphalt shingle waste or combination of both manufacturer and consumer asphalt shingle waste. In some embodiments, a binder blend may include at least about 20 wt. %, or greater than 20 wt. % of RAP, RAS or mixture of RAP and RAS. In certain embodiments an asphalt binder blend may include as much as 80 wt. % of RAP, RAS or mixture of RAP and RAS. In other embodiments, a binder blend may include about 60 wt. % to about 95 wt. % of virgin binder and from about 5 wt. % to about 40 wt. % of RAP. In addition, some embodiments are binder blends including from about 5 wt. % to about 40 wt. % of RAS (reclaimed asphalt shingles, material extracted from manufacturer asphalt shingle waste, from consumer asphalt shingle waste, or from a mixture of binders extracted from manufacturer and consumer asphalt shingle waste) and about 60 wt. % to about 95 wt. % of virgin binder. In certain embodiments, the binder blend includes the addition of an age retarding additive from about 0.5 wt. % to about 15.0 wt. % of the virgin asphalt binder. In certain embodiments, the binder blend can include the addition of from about 0.2 wt. % to about 1.0 wt. % age retarding additive. The age retarding additive has been shown to improve high and low temperature properties and Performance Grading (PG) for both low and high temperature ends of RAP-containing asphalt binder blends, RAS-containing asphalt binder blends, or both RAP-containing and RAS-containing asphalt binder blends.

Asphalt binder compositions can be prepared by applying mechanical or thermal convection. In some embodiments, a method of preparing an asphalt binder composition involves mixing the asphalt binder with an age retarding additive and to RAS or RAP at a temperature of from about 100° C. to about 250° C. In certain embodiments, the asphalt binder is mixed with age retarding additive and RAP, RAS, or RAM (reclaimed asphalt material, which is a mix of both RAP and RAS) at a temperature of from about 125° C. to about 175° C., or about 180° C. to about 205° C. In some embodiments, the asphalt binder composition is mixed with i) virgin asphalt, ii) RAP, RAS, or RAM, iii) age retarding additive, and iv) softening agent. In still other embodiments, the asphalt binder composition is mixed with i) virgin asphalt, ii) RAP, RAS, or RAM, iii) age retarding additive and iv) aggregate. The aggregate may be any materials that are useful in the preparation of asphalt mixes such as, but not limited to, limestone, granite, and trap rock. The size and properties of aggregate materials are typically specified by the agency or customer and generally must conform to governmental requirements for the specific project on which the final mixture will be placed. The order of mixing the components of the asphalt binder composition is not limited. The composition may be prepared by mixing the binder with age retarding additive followed by the addition of RAP, RAS, or RAM and, in some cases, virgin aggregate. The binder may also be mixed first with RAP, RAS, or RAM, followed by addition of age retarding additive and the aggregate. In yet another embodiment, the binder, age retarding additive, and RAP, RAS or RAM, are added together at the same time, followed by the addition of the aggregate. One of skill in the art will recognize that other sequences of adding and mixing components are possible.

### EXAMPLES

### Comparative Example 1. Aging Retarding Properties of Cholestane and Cholestanol

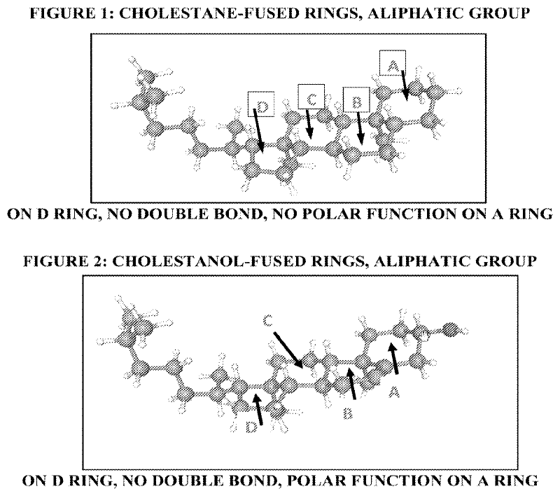

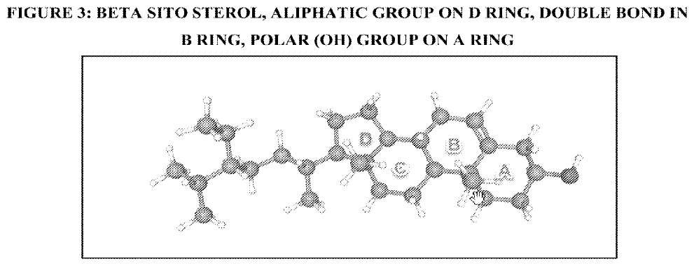

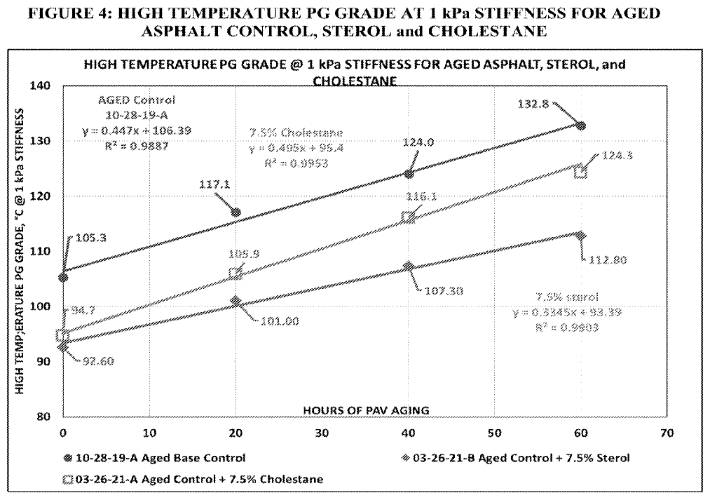

This example provides data (FIG. 4) showing that cholestane (which as shown in FIG. 3 does not possess an —OH (hydroxyl) group on ring A or a double bond on ring B but does have an aliphatic side chain off the 5-member ring D) does not provide the asphalt binder age retarding properties that arise when phytosterols or cholesterol are added to bitumen. Cholestane and cholestanol molecular structures are shown below and in more detail in FIGS. 1 and 2, respectively, and the chemical structures below.

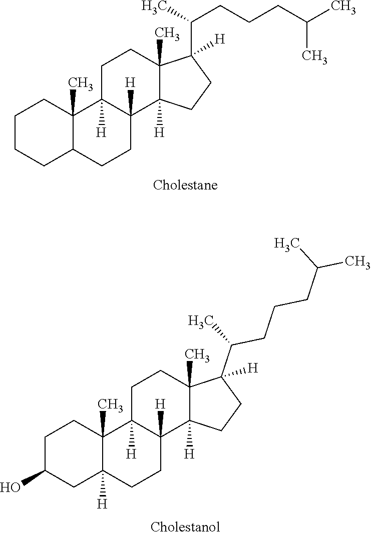

FIG. 4 shows plots for the high temperature PG Grade aged by three 20 hour of PAV conditioning procedures as described in ASTM D6521 or AASHTO R 28. Similar aging for a sample of asphalt binder with no age retarding additive served as a control compared to the properties of a blend of 7.5% cholestane and also compared to a blend of 7.5% sterol in the aged asphalt control. Both additives were blended into an asphalt binder that had been laboratory aged to approximate asphalt recovered from RAP. The aging slopes for these three samples show that the sample containing cholestane ages at a rate faster than the sample into which the sterol had been added. Although cholestane and sterol samples differ by 2° C. at the initial or zero time, after 60 hours of PAV aging, they differ by 12° C. with the cholestane blend having a higher high temperature PG grade than the sterol blend. Higher high temperature PG grades are indicative of binders that have poor relaxation properties and are prone to cracking due to traffic loading and exposure to cold environmental temperatures.

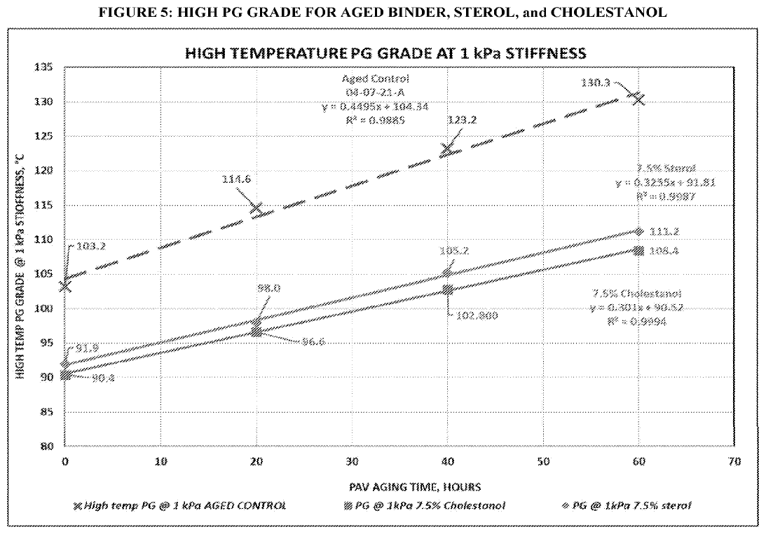

FIG. 5 shows plots through 60 hours for PAV aging of the high temperature PG grade of an aged control binder and samples of 7.5% cholestanol and 7.5% sterol in same aged control. Between the time the cholestane work discussed in FIG. 4 had been completed and the work with cholestanol commenced, the aged binder used for the cholestane investigation had been consumed and a new batch of laboratory aged binder was produced. The data for the two batches of aged control were similar as subsequent data will show. Analysis of the high temperature data for the aged control binder presented in FIG. 4 and high temperature data for the aged control presented in FIG. 5 shows an average of 2° C. difference for the four high temperature results. Although the aged control binders were different their similar aging properties enable meaningful comparisons to the data in FIG. 4. The high temperature results presented in FIG. 5 show that cholestanol and sterol age at similar and lower rates than the aged control binder. The sterol blend has slightly higher values than does the cholestanol, but both have nearly the same aging slopes compared to the control binder which has a higher aging slope. Also, the aging slope of the aged control binder used for the blends in FIG. 4 was 0.447 and the aging slope for the aged control used for the FIG. 5 blends was 0.4495. These similarities in aging slopes for the control binders provide further indications that the aged control binders would behave similarly when treated with the same additives. The aging slope for 7.5% sterol in FIG. 4 was 0.3385 and the aging slope for the 7.5% sterol in FIG. 5 was 0.3255: once again very similar properties for blends of the same additive at the same concentration.

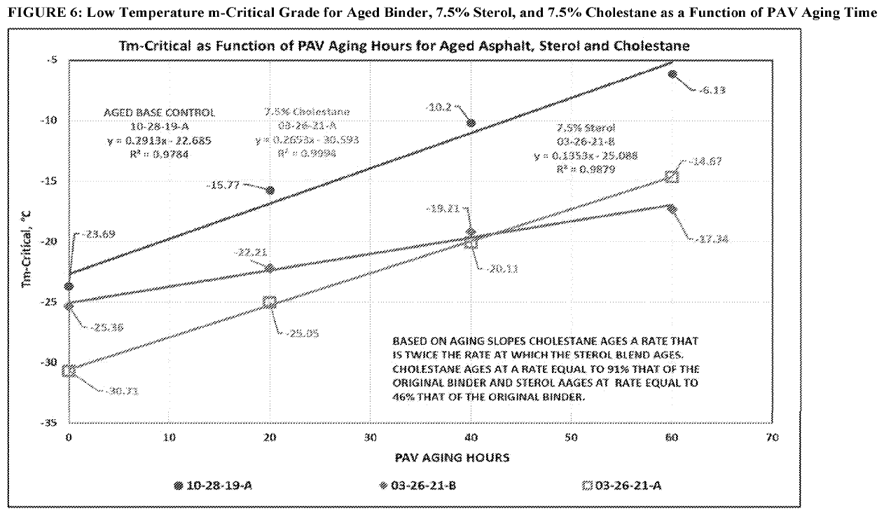

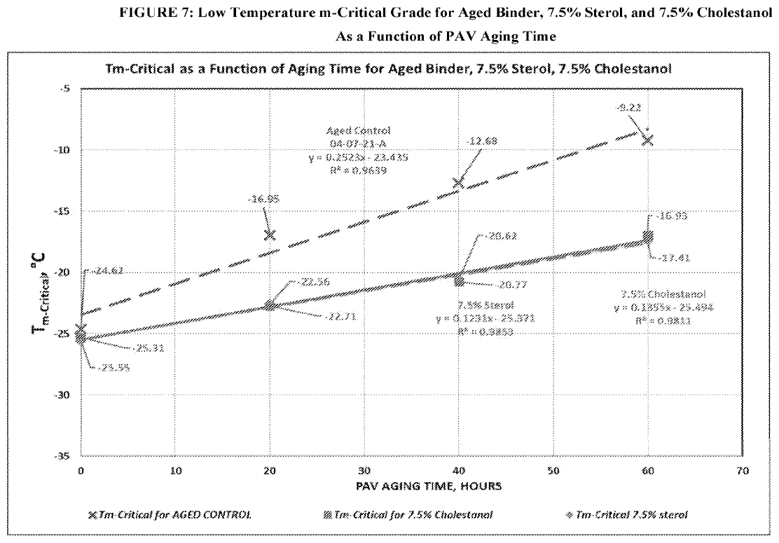

FIGS. 6 and 7 compare low temperature m-Critical grade (Tm-Critical) values for comparative blends of sterol and cholestane (FIG. 6) and sterol and cholestanol (FIG. 7). FIG. 6 shows cholestane reduces the low temperature grade to a greater extent than does the sterol. This behavior is often observed when softening additives are blended with aged binder. The data in FIG. 6 shows that cholestane ages at nearly the same aging rate as the original binder whereas the sterol blend ages at a decreased rate which is less than half the aging rate of the aged control binder. As has been observed with some softening additives, such as bio-oil additives, compared to sterol an aging point arrives where the more rapid aging rate of the softening additive intersects the aging rate trend line of the more slowly aging sterol blend. For the data in FIG. 6 this intersection point is reached at 40 hours of aging. The data shows the sterol has a better low temperature value after 60 hours compared to cholestane. FIG. 7 shows that both cholestanol and sterol have low temperature aging rates that are nearly identical and the Tm-Critical plots overlay. This is an indication of the importance of the molecular structure in establishing the age retarding properties of the final sample.

The disclosed results also show that sterol blended in asphalt binder does not disappear or otherwise become solubilized or inactivated within the binder. When an Iatroscan GC-FID evaluation of a binder is performed on an unaged blend of sterol in binder and compared to a 60-hour aged sample of the same material, the sterol peak shows the same areas are present after aging. Testing of aged sterol-containing binder shows the sterol present within the aged binder. When combined with non-sterol containing aged binders, the age retarding impact of the sterol is present. Data supporting these results is presented in some of the references cited at the beginning of this disclosure.

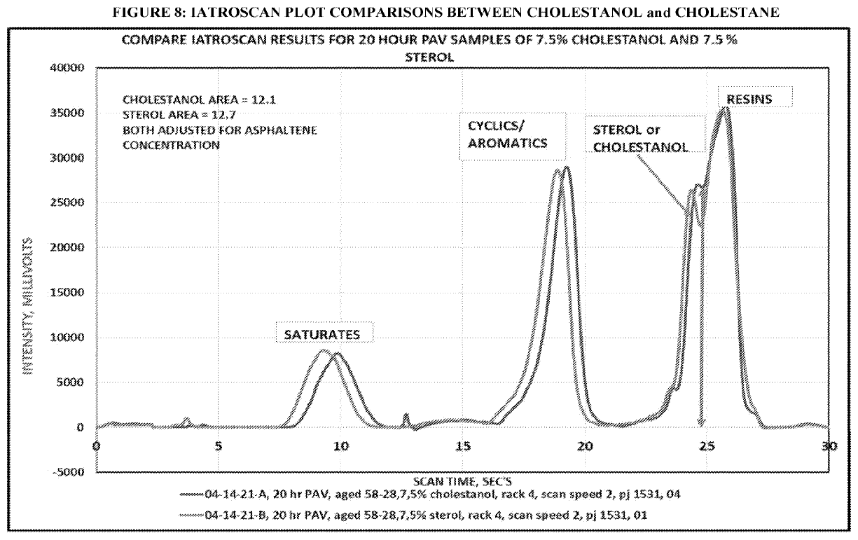

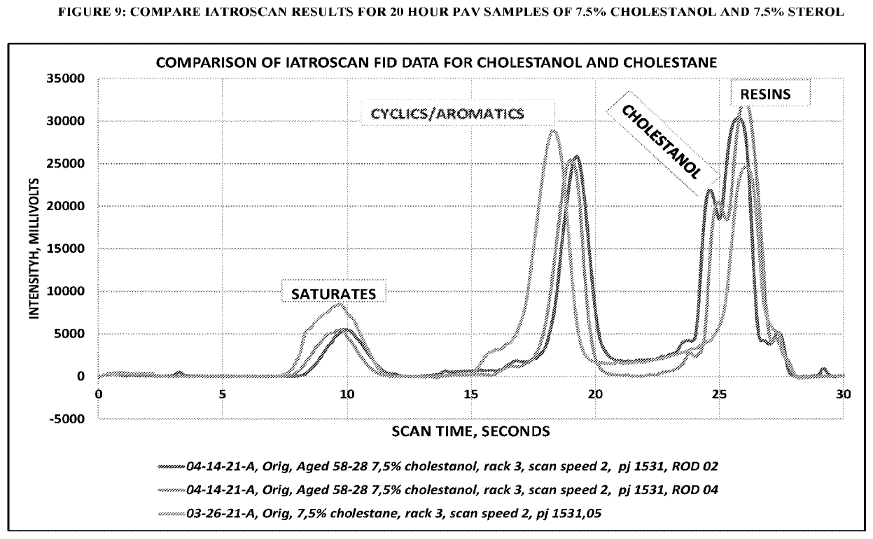

To determine if cholestane and/or cholestanol were chemically functioning in a manner comparable to sterol, Iatroscan testing of some blends was performed. FIG. 8 shows Iatroscan results for 20-hour PAV aged samples of 7.5% sterol and 7.5% cholestanol. As the scan shows there are separate peaks prior to the main resin peaks of the Iatroscan for both sterol and cholestanol. The cholestanol peak is not as separated from the resins but the area can be determined and the area results for the two additives are similar.

FIG. 9 is a plot of two Iatroscan tests for a cholestanol sample and a sample of cholestane. These tests were performed on unaged binder. The cholestane sample used a different aged binder control than the cholestanol. There is no initial peak as a precursor to the main resin peak for the cholestane sample and the resin peak for the cholestane sample is the lowest of the three samples implying that the cholestane is present elsewhere in the binder. The saturate area for the unaged cholestane sample is 12.1 area units and the saturate area in the aged base was 6.3; therefore, the additional saturate area is 5.8 units. These data suggest that the cholestane is contained in the saturate fraction not as a separate peak, but as part of the total area. Because cholestane is a saturated molecule these results show cholestane eluting with the saturates.

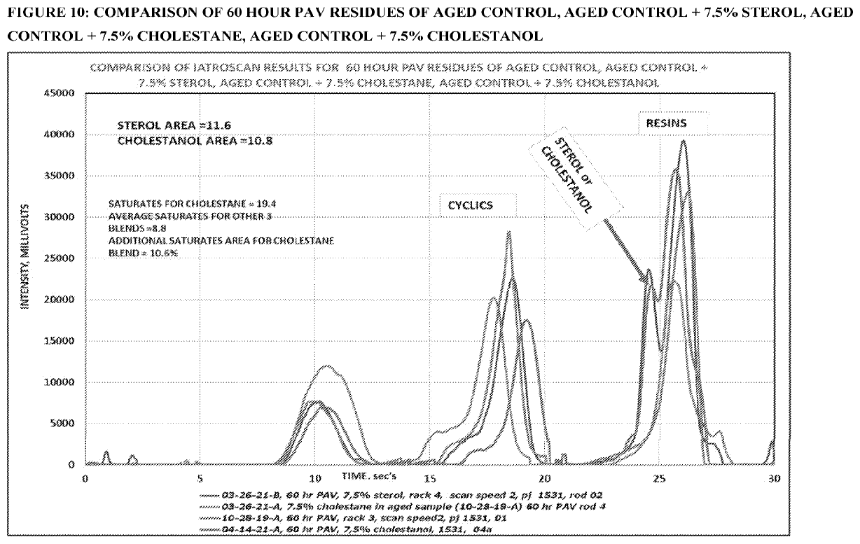

FIG. 10 plots Iatroscan results for 60-hour PAV aged samples consisting of an aged control binder (10-28-19-A), 7.5% cholestane and 7.5% sterol in the aged control binder and 7.5% cholestanol in the new sample of aged control binder referenced earlier in this document. After 60 hours of aging the sterol and cholestanol remain present as precursor peaks to the binder resin fraction. Even though the sterol and cholestanol were blended into different aged control binders, their relative amounts as delineated by the peaks for those additives differ by only 0.8 area units. This similarity in the precursor peaks for the sterol and cholestanol blends suggests that both substances behave chemically similarly and that both are present in their original form after aging. The saturate area of the 7.5% cholestane sample equals 19.4, which as the Iatroscan plots show, is substantially greater than the saturate area for the other three samples. Considering that the sterol area for sample 03-26-21-B was 11.6 area units and the cholestanol area for sample 04-14-21-A is 10.8 area units when both samples contained 7.5% of their respective additives, an additional cholestane area of 10.6 area units within the saturate fraction suggests that the additional saturate area is due to cholestane. These data also suggest that cholestane, although it does not retard aging as has been shown, also does not appear to degrade or be consumed during the aging of the binder. This observation provides evidence that the fused ring structure of a sterol-based additive is unreactive under asphalt aging conditions. This is also evidence that the polar functionality in a sterol-based additive provides the mechanistic properties that retard aging because the cholestane structure, for example, lacks polar functionality and exhibits no age retarding properties.

Overall molecules with specific characteristics can be blended into asphalt binder and subjected to the aging process without being consumed or degraded. Some of these structures, such as sterol or cholestanol, are capable of retarding the aging rate of asphalt binders. In addition, other molecules with similar chemical functionalities and structures behave in a similar manner. Molecules that do not have the minimal chemical functionality of having a polar functional atom or structure and/or a double bond in at least one of the 6 member rings close to the polarity functional species do not appear to provide age retarding properties. Based on the cholestane data the fused group of saturated ring structures tested but with an aliphatic chain of 5 or 6 carbon atoms provides no age retarding function but reduces stiffness of the binder into which it is added. Although the initial softening affect is comparable to the impact of softening additives, such as bio-oil additives, the present data generated shows that cholestane did not age at a rate substantially faster than the aging rate of the original binder. This could be due to the fact that cholestane does not contain oxygen or other reactive sites (such as double bonds) to accelerate aging. The behavior of cholestane compared to cholestanol in tests show that the sterol structure and the stanol structure (by elimination of the double bond) is suitable for retarding binder aging rates.

Molecules with four or more saturated rings, a molecular dipole moment depending on the magnitude and direction of individual polar bonds and their dipole moments, a molecular weight in the 300-400 g/mol range, and a melting point of at least 250° F. and higher will provide age-retarding benefits in asphalt binders. In the disclosed embodiments, the —OH moiety provides improved age retardation properties, and it will be the least reactive in the bitumen.

1. An asphalt binder composition comprising virgin binder, aged asphalt binder comprising asphalt binder derived from reclaimed asphalt pavement (RAP), reclaimed asphalt shingles (RAS) or a combination of both, and an age-retarding additive comprising three structural elements i) a fused hydrocarbon ring structure, ii) a polar element A attached to the ring structure, and iii) an aliphatic element R1 attached to the fused hydrocarbon ring structure opposite the polar element according to Formula 1:
Polar Element A-Fused Hydrocarbon Ring Structure-Aliphatic Element R1 Formula 1.

2. The asphalt binder composition of claim 1 wherein the Polar Element A comprises a hydroxyl moiety, halogen moiety, sulfur-based moiety, or nitrogen-based moiety, wherein the Fused hydrocarbon Ring Structure comprises multiple fused aliphatic rings of about 12 to about 24 carbon atoms, optionally including one or more attached methyl moieties or one or more double bonds in one or more of the fused rings, and wherein the Aliphatic Element R1 comprises a linear or branched alkyl, or alkenyl moiety having about 2 to about 16 carbon atoms.

3. The asphalt binder composition of claim 1 wherein when the Polar Element A is a hydroxyl moiety and the fused ring structure is a ring structure other than the fused four ring structure of Formula 2 or Formula 3:

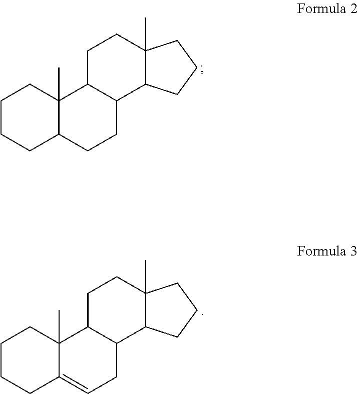

4. The asphalt binder composition of claim 1 wherein the Polar Element A comprises —OH, —ORₐ, —OCO—Rₐ, Rₐ—CO₂H, —F, —Cl, —Br, —SH, —SO—, —SO₂, —NH₂, —NHRₐ, or —N(RₐR_{b}), wherein Rₐ and R_{b} are C₁-C₁₀ linear or branched alkyl or alkenyl groups, optionally having one or more hydroxyl moieties.

5. The asphalt binder composition of claim 1 wherein the fused ring structure is rigid, unsaturated, and essentially non-reactive.

6. The asphalt binder composition of claim 1 wherein the rigid fused ring structure is rigid, saturated, and essentially non-reactive.

7. The asphalt binder composition of claim 1 wherein the fused ring structure comprises seventeen carbon atoms.

8. The asphalt binder composition of claim 1 wherein the fused ring structure comprises four six membered fused rings.

9. The asphalt binder composition of claim 1 wherein the age retarding additive comprises a molecular weight of about 250-1,000 g/mol.

10. The asphalt binder composition of claim 1 wherein the age retarding additive comprises a molecular weight of about 250-650 g/mol., a molecular weight of about 300-550 g/mol, or a molecular weight of about 325-425 g/mol.

11. (canceled)

12. (canceled)

13. The asphalt binder composition of claim 1 wherein the age retarding additive comprises a melting point of at least about 150° F. or higher.

14. The asphalt binder composition of claim 1 wherein the age retarding additive comprises a melting point melting point of about 250° F. to about 500° F.

15. The asphalt binder composition of claim 1, wherein the age-retarding additive is about 0.5 wt. % to about 15 wt. %, of the virgin binder weight.

16. The asphalt binder composition of claim 1 comprising about 20 wt. % or greater amounts of RAP.

17. The asphalt binder composition of claim 1 comprising about 20 wt. % or greater amounts of RAS.

18. The asphalt binder composition of claim 1 comprising about 20 wt. % or greater amounts of a mixture of RAP and RAS.

19. The asphalt binder composition of claim 1 comprising about 60 wt. % to about 95 wt. % of virgin binder and from about 5 wt. % to about 40 wt. % of RAP.

20. The asphalt binder composition of claim 1 comprising about 60 wt. % to about 95 wt. % of virgin binder and about 5 wt. % to about 40 wt. % of RAS.

21. The asphalt binder composition of claim 1 further comprising added aggregate.

22. A paved surface comprising the asphalt binder composition of 1 with added aggregate compacted over a base surface to form the paved surface.
